(19) United States
(12) Patent Application Publication
(10) Pub. No.: US 2010/0259121 A1
(43) Pub. Date: Oct. 14, 2010

(54) POWER TRANSMISSION DEVICE

(75) Inventors: Motohiko Ueda, Okazaki-city (JP); Takuo Sakai, Kariya-city (JP); Hiroshi Kishita, Anjo-city (JP); Yuichi Ohno, Nishio-city (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-city, Aichi-pref. (JP); NIPPON SOKEN, INC., Nishio-city, Aichi-pref. (JP)

(21) Appl. No.: 12/734,161

(22) PCT Filed: Oct. 23, 2008
(86) PCT No.: PCT/JP2008/003006

§ 371 Date: Apr. 15, 2010

(51) Int. Cl. H02K 49/06

(52) U.S. Cl. 310/103

(57) ABSTRACT

A power transmission device for transmitting a driving force from a vehicle-mounted driving source to a vehicle-mounted rotary device includes a driving rotor mechanically coupled to the vehicle-mounted driving source via a belt, and a driven rotor disposed coaxially with the driving rotor and mechanically coupled to a drive shaft of the vehicle-mounted rotary device. Furthermore, the power transmission device is provided with a magnetic join portion disposed in at least one of the driving rotor and the driven rotor, and the magnetic join portion is adapted to transmit a rotary driving force from the driving rotor to the driven rotor by a magnetic force, while keeping a predetermined clearance between the driving rotor and the driven rotor. Thus, in the power transmission device, a natural frequency can be made much lower than a frequency of vibration generated from the vehicle-mounted rotary device in idling of a vehicle.

### CROSS REFERENCE TO RELATED APPLICATION

This application is based on Japanese Patent Applications No. 2007-279177 filed on Oct. 26, 2007 and No. 2008-268420 filed on Oct. 17, 2008, the contents of which are incorporated herein by reference in its entirety.

### TECHNICAL FIELD

The present invention relates to a power transmission device for transmitting power from a driving source to a vehicle-mounted rotary device.

### BACKGROUND ART

Conventionally, power transmission devices for transmitting power from a driving source to a vehicle-mounted rotary device, such as a compressor for a vehicle air conditioner, include a damper mechanism made of an elastic member, such as rubber or elastomer, for attenuating vibration of the vehicle-mounted rotary device due to variations in load torque (as disclosed in, for example, JP 2005-201433A).

The power transmission device is subjected to vibrations generated from a compressor or vehicle-mounted rotary devices other than the compressor. When the frequency of vibration generated from the vehicle-mounted rotary device is identical to a natural frequency of the power transmission device, the power transmission device may be resonated to have its vibrations increased.

Vibration magnifications due to the resonance generally make a curved line shown in FIG. 6. At a frequency ratio (i.e., a ratio of the frequency of vibration to the natural frequency) of 1, the vibration is most amplified. As the frequency ratio is increased to more than 1, the vibration magnification is known to gradually approach zero. That is, in order to suppress the amplification of vibration generated due to the resonance, it is effective to sufficiently increase the frequency ratio of the frequency of vibration generated from the vehicle-mounted rotary device to the natural frequency of the power transmission device to more than 1 in the range of use of the power transmission device.

The frequency of vibration generated from the vehicle-mounted rotary device normally takes the lowest value in idling of vehicles. In order to constantly make the frequency ratio much more than 1, it is effective to set the natural frequency of the power transmission device much lower than the frequency of the vibration generated from the vehicle-mounted rotary device in idling.

In such a power transmission device with a damper mechanism made of elastic member, such as rubber or elastomer, as that disclosed in JP 2005-201433A, the damper mechanism needs to be made of soft rubber or elastomer thereby to decrease a spring constant so as to reduce the natural frequency of the power transmission device. However, the amount of deformation of rubber or elastomer may become large, and thereby it disadvantageously results in shortened service life of the damper mechanism.

In contrast, when a damper mechanism made of hard rubber or elastomer has a large body, the spring constant can be decreased. However, the excessively large body of the damper mechanism makes it difficult to apply the damper mechanism to the power transmission device to be mounted on a vehicle, thereby proving impractical.

### DISCLOSURE OF THE INVENTION

The present invention has been made in view of the forgoing problems, and it is an object of the present invention to provide a power transmission device having a natural frequency much lower than the frequency of vibration generated from a vehicle-mounted rotary device in idling of a vehicle.

In order to achieve the above object of the present invention, according to an aspect of the present invention, a power transmission device is for transmitting a driving force from a vehicle-mounted driving source to a compressor included in a refrigeration cycle of an air conditioner for a vehicle via a belt. The power transmission device includes a driving rotor coupled to the vehicle-mounted driving source via the belt, a driven rotor disposed coaxially with the driving rotor and mechanically coupled to a drive shaft of the compressor, and a magnetic join portion disposed in at least one of the driving rotor and the driven rotor. The magnetic join portion is adapted to transmit a rotary driving force from the driving rotor to the driven rotor by a magnetic force, while keeping a predetermined clearance between the driving rotor and the driven rotor. In the power transmission device, a maximum rotary driving force transmitted from the driving rotor to the driven rotor by the magnetic join portion is set larger than a maximum torque required by the compressor, and smaller than at least one of a torque at which the driving rotor and the belt start to slip, a torque at which the vehicle-mounted driving source is stopped, and a maximum torque generated from a starter in startup of the vehicle-mounted driving source.

According to the above aspect of the present invention, the magnetic join portion transmits a rotary driving force from the driving rotor to the driven rotor by a magnetic force, while keeping the predetermined clearance between the driving rotor and the driven rotor, and further acts as a damper mechanism. The power transmission device of the present invention can decrease the spring constant of the damper mechanism without taking into consideration the durability and body size of rubber, elastomer, or the like as compared to a power transmission device with a damper mechanism made of only elastic member, such as rubber or elastomer. As a result, the power transmission device of the present invention can sufficiently reduce the natural frequency as compared to the frequency of vibration generated from the vehicle-mounted rotary device in idling of the vehicle.

For example, the magnetic join portion may, be configured by permanent magnets arranged in the circumferential direction. More specifically, the maximum rotary driving force transmitted by the magnetic join portion from the driving rotor to the driven rotor is set to not less than 15 Nm and not more than 150 Nm, so that the rotary driving force can be transmitted without problems in practical use by the power transmission device used in a compressor included in a refrigeration cycle of an air conditioner for the vehicle.

### BRIEF DESCRIPTION OF DRAWINGS

FIG. 1 is a cross-sectional view of a power transmission device according to a first embodiment of the present invention;

FIG. 2 is a diagram of the power transmission device of the first embodiment as viewed from the opposite side to a compressor in the axial direction;

FIG. 3 is an enlarged view of a part of FIG. 2;

FIG. 4 is a graph showing the relationship between a displacement angle between a driven permanent magnet and a driving permanent magnet, and a torque transmitted from a pulley to an outer hub by magnetic adsorption means;

FIG. 5 is a cross-sectional view of a power transmission device according to a second embodiment of the present invention;

FIG. 6 is a diagram showing vibration magnifications due to resonance;

FIG. 7 is a cross-sectional view of an electromagnetic clutch (power transmission device) according to a third embodiment of the present invention;

FIG. 8 is a diagram showing a magnetic circuit of the electromagnetic clutch of the third embodiment; and

FIG. 9 is a cross-sectional view of an electromagnetic clutch (power transmission device) according to a fourth embodiment of the present invention.

### BEST MODE FOR CARRYING OUT THE INVENTION

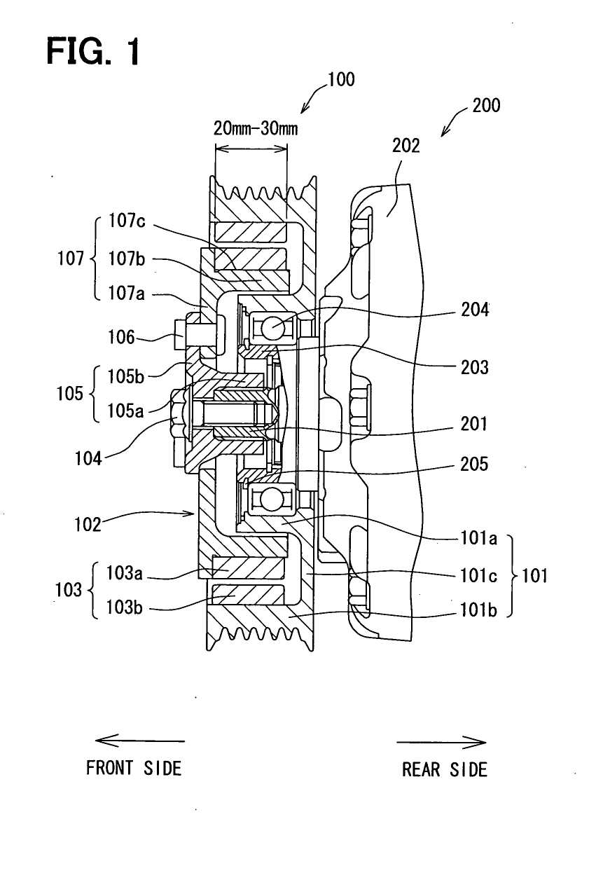

In the following, for convenience, the left side on the paper and the right side on the paper in each of FIGS. 1, 5, and 7 to 9 are hereinafter referred to as the front side of a power transmission device and the rear side of the power transmission device, respectively.

### First Embodiment

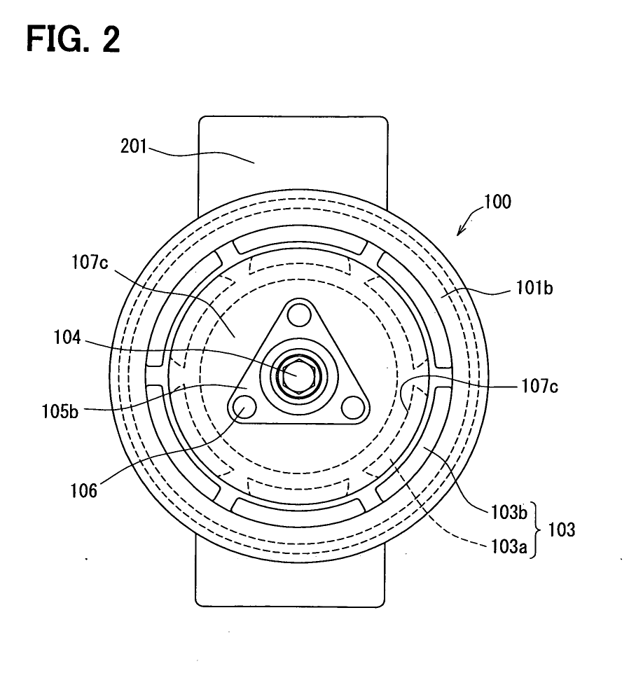

First, the structure according to a first embodiment of the present invention will be described below with reference to FIGS. 1 and 2. FIG. 1 is a cross-sectional view of a power transmission device 100 in the first embodiment. The power transmission device 100 of the embodiment transmits a driving force from a vehicle-mounted driving source, such as an internal combustion engine (not shown) or a motor for vehicle traveling, to a compressor 200 included in a refrigeration cycle of an air conditioner for a vehicle via a belt (not shown).

The power transmission device 100 includes a pulley 101 mechanically coupled to the vehicle driving source via the belt, a hub 102 arranged coaxially with the pulley 101 and mechanically coupled to a drive shaft 201 of the compressor 200, and a magnetic join portion 103 disposed in both pulley 101 and hub 102. The magnetic join portion 103 is adapted to transmit a rotary driving force from the pulley 101 to the hub 102 by a magnetic force, while keeping a predetermined clearance between the pulley 101 and the hub 102.

The pulley 101 is made of a magnetic material, preferably iron. The pulley 101 includes an inner ring 101a pivotally supported by a boss 203 of a housing 202 of the compressor 200 through a radial bearing 204, an outer ring 101b having V-like grooves at its outer perimeter over which the belt (not shown) is looped, and a joint 101c for joining the inner ring 101a and the outer ring 101b.

That is, the pulley 101 is rotatably supported by the boss 203 standing toward the front side from the end of the compressor 200 in the axial direction of the housing 202 via the single-row radial roller bearing 204.

The radial bearing 204 is inserted into the boss 203 after being pressed into the inner periphery of the inner ring 101a of the pulley 101, and held by a collar 205.

The hub 102 includes an inner hub 105 fixed to the drive shaft 201 of the compressor 200 by a bolt 104, and an outer hub 107 fixed to the outer perimeter of the inner hub 105 by a rivet 106.

The inner hub 105 includes a cylindrical portion 105a having a concavo-convex fitting portion at its inner perimeter and into which the end of the drive shaft 201 is fitted, and a flange 105b protruding in the radial direction from the end in the axial direction of the cylindrical portion 105a on the opposite side to the compressor. The end of the cylindrical portion 105a on the opposite side to the compressor is provided with a hole which the bolt 104 penetrates. The bolt 104 penetrates the hole, and is screwed into a bolt hole formed at the tip end of the drive shaft 201. The periphery of the hole formed at the end of the cylindrical portion 105a on the opposite side to the compressor has its rear side pushed against an end surface of the drive shaft 201 by screwing of the bolt 104. The end of the cylindrical portion 105a on the compressor side extends from the outside in the axial direction of the boss 203 protruding from the housing 202 of the compressor 200 to the inside in the axial direction of the boss 203. The outer wall of the cylindrical portion 105a forms a predetermined clearance from an inner wall of the boss 203. The flange 105b has a substantially triangle shape as viewed in the axial direction. The outer hub 107 and the flange 105b are fixed together at the respective vertices of the substantially triangle shape by three rivets 106 (see FIG. 2).

The outer hub 107 is made of a magnetic material, preferably iron. The outer hub 107 is fixed to the flange 105b of the inner hub 105 by three rivets 106. The outer hub 107 includes a doughnut-shaped disk 107a having a hole which the cylindrical portion 105a of the inner hub 105 penetrates, and a ring-like protrusion 107b extending from the disk 107a toward the compressor side in the axial direction. The disk 107a is disposed spaced apart from the tip end in the axial direction of the boss 203 protruding from the housing 202 of the compressor 200 by a predetermined clearance in the axial direction so as not to be in contact with the end of the boss. The protrusion 107b extends so as to be positioned in a ring-like concave portion enclosed by the inner ring 101a, the outer ring 101b, and the joint 101c of the pulley 101. The protrusion 107b, the inner ring 101a, the outer ring 101b, and the joint 101c of the pulley 101 are disposed spaced apart by a predetermined gap without being in contact with each other.

The outer peripheral surface of the protrusion 107b is provided with the grooves 107c disposed in the circumferential direction. The groove has an area of a bottom surface wider than an opening area of an entry portion. The end of the groove 107c on the non-compressor side in the axial direction is covered with the disk 107a and not opened. In contrast, the end of the groove 107c on the compressor side in the axial direction is opened.

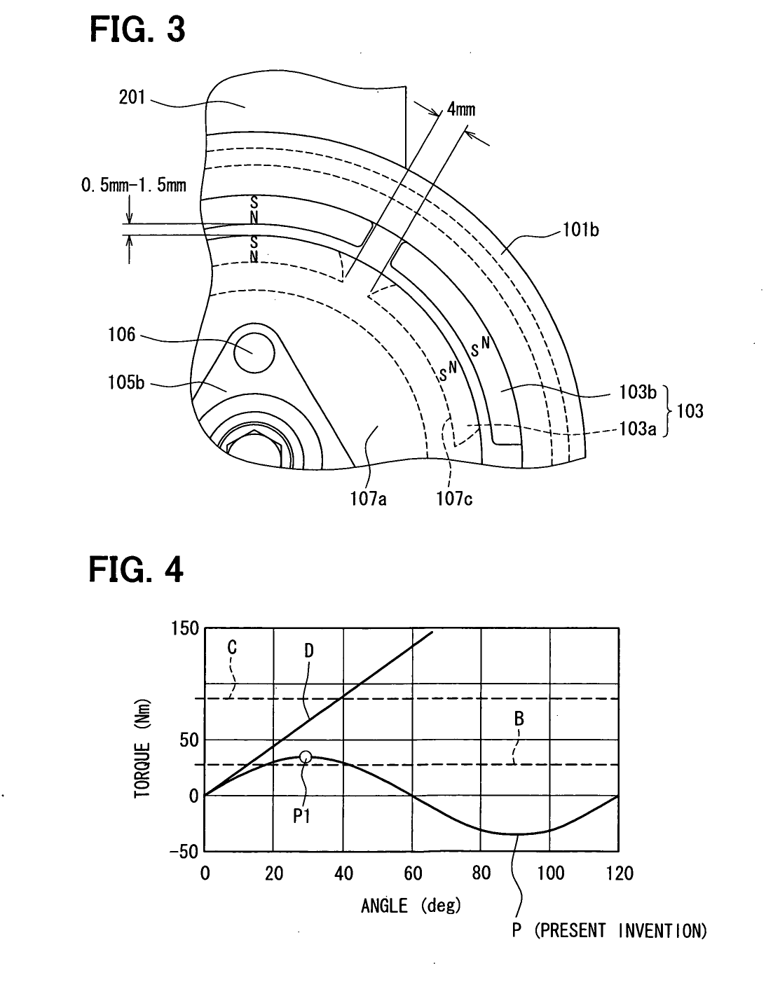

The magnetic join portion 103 of the embodiment includes a plurality of driven permanent magnets 103a, each bonded to the groove 107c by an adhesive after being fitted into the groove 107c from the end thereof on the compressor side in the axial direction, and a plurality of driving permanent magnets 103b, each bonded to the inside of the outer ring 101b of the pulley 101 by the adhesive. Both the driven permanent magnet 103a and the driving permanent magnet 103b have an arc-shaped section. An even number of the driven and driving permanent magnets 103a and 103b are respectively arranged concentrically at equal intervals in the circumferential direction as shown in FIG. 3. The adjacent magnets in the circumferential direction are disposed such that N poles and S poles are alternately arranged, and that the N pole of one magnet is opposed to the S pole of the other magnet facing the one magnet.

The driven permanent magnet 103a and the driving permanent magnet 103b are desirably ones which have little change in magnetic force due to a change in temperature and which are not demagnetized even at 150° C. or more. This is because the inside of an engine room of a vehicle with the power transmission device disposed therein can be heated to a high temperature of 150° C. or more.

In the embodiment, a neodymium magnet or samarium-cobalt magnet is used as the driven permanent magnet 103a and the driving permanent magnet 103b, and these permanent magnets are respectively attached to the outer ring 101b of the pulley 101 and the ring-like protrusion 107b of the outer hub 107, and then magnetized.

In the embodiment, six driven permanent magnets 103a and six driving permanent magnets 103b are respectively disposed. A clearance in the radial direction between the driven permanent magnet 103a and the driving permanent magnet 103b which are opposed to each other is 0.5 to 1.5 mm. A distance between the driven permanent magnets 103a adjacent in the circumferential direction (between the driving permanent magnets 103b) is about 4 mm. The driven permanent magnet 103a and the driving permanent magnet 103b have a size in the axial direction of 20 to 30 mm. The bottom face of the groove 107c of the outer hub 107 and the outer ring of the pulley 101 preferably have a thickness of 2 mm or more so as to serve as a back yoke by allowing most of magnetic fluxes generated from the driven permanent magnet 103a and the driving permanent magnet 103b to pass through a magnetic material. An effective diameter of the pulley 101 in the embodiment is about 100 mm.

Next, the operation and effect of the first embodiment will be described below using FIG. 4. FIG. 4 is a graph showing the displacement angle between the driven permanent magnet 103a and the driving permanent magnet 103b, and the level of the torque transmitted from the pulley 101 to the outer hub 107 by the magnetic join portion 103. As to the displacement angle shown in FIG. 4, an angle at which the N pole (or S pole) of the driven permanent magnet 103a and the S pole (or N pole) of the driving permanent magnet 103b are most strongly attracted to each other is set to zero (0) degrees. As to the torque shown in FIG. 4, a torque in the normal rotational direction of the pulley 101 is indicated by a positive numerical value, whereas a toque in the reverse rotational direction of the pulley 101 is indicated by a negative numerical value, both torques being represented in terms of Nm. In FIG. 4, a graph P indicates the characteristics of the first embodiment of the present invention, and a point P1 indicates the maximum torque transmittable by the magnetic join portion 103. Further, in FIG. 4, a line B indicates the maximum torque generated in the compressor, a line C indicates a toque at which the pulley 101 starts to slip on the belt, and a line D indicates the characteristics of a damper mechanism using rubber, elastomer, or the like.

When the pulley 101 is driven via the belt, the driving permanent magnet 103b disposed inside the outer ring 101b of the pulley 101 also rotates to attract the driven permanent magnet 103a in the normal rotational direction by a magnetic force. The tension at this time becomes torque transmitted from the pulley 101 to the outer hub 107. When T is a toque, and θ is a displacement angle between the driven permanent magnet 103a and the driving permanent magnet 103b, the embodiment satisfies the following formula: T=A sin(θ/X). The amplitude A may be selected in such a manner that the maximum value of sin(θ/X) is located between the maximum torque generated in the compressor and the toque at which the pulley 101 starts to slip on the belt. The amplitude can be, for example, A=30. Further, X is a constant defined according to the number N of permanent magnets. The X satisfies the formula of X=N/2, and is X=3 in the embodiment.

In the range of angles where the sin(θ/X) is not less than 0 nor more than 1, the magnetic join portion 103 acts as a conventional damper mechanism made of only elastic member, such as rubber or elastomer, so as to decrease the displacement angle θ between the driven permanent magnet 103a and the driving permanent magnet 103b.

Referring to FIG. 4, the spring constant of the damper mechanism, namely, the magnetic join portion 103 is determined by differentiation of the torque T. For A=30 and X=3, when the spring constant is represented by k, the spring constant is determined by the formula of k=dT/dθ=90 cos(θ/3). In the range of angles where a sin(θ/3) is not less than 0 nor more than 1, the spring constant is sufficiently small as compared to a spring constant (of about 120 Nm/rad) of the conventional damper mechanism made of only elastic material, such as rubber or elastomer. Further, in the range of angles where a sin(θ/3) is not less than 0 nor more than 1, as the value of θ becomes larger, the spring constant can be made smaller, and the average spring constant in an operating range of the compressor becomes small in evaluating the magnetic join portion 103 as the damper mechanism.

According to the embodiment, the spring constant of the damper mechanism can be sufficiently made small as compared to the damper mechanism made of only elastic material, such as rubber or elastomer, so that the natural frequency of the power transmission device can be made much lower than the frequency of vibration (of about 80 Hz) generated from the vehicle-mounted rotary device in idling of the vehicle.

As a result, the frequency ratio of the frequency of vibration generated from the vehicle-mounted rotary device to the natural frequency of the power transmission device can constantly be much more than 1 (preferably, equal to or more than 1.5).

The maximum torque transmittable by the magnetic join portion 103 (torque obtained at sin(θ/X) of 1, that is, 30 Nm for A=30 in the embodiment) is set higher than the maximum torque normally generated by the compressor 200, and lower than the torque at which the pulley 101 starts to slip on the belt (not shown). In case where the drive shaft 201 of the compressor 200 is locked due to invasion of foreign material, even when the pulley 101 is intended to rotate at a torque larger than the maximum torque normally generated by the compressor 200, the pulley 101 and the outer hub 107 idle without transmitting the torque larger than the maximum torque (torque at the sin(θ/X) of 1) to the outer hub 107 via the magnetic join portion. Thus, the pulley 101 and the belt can be prevented from slipping, so that the damage to the belt can be avoided. Thus, the embodiment does not need a limiter mechanism, which is conventionally required separately, for interrupting the transmission of power by breaking a part of the mechanism under excessive load torque.

The limiter mechanism conventionally required separately for interrupting the power transmission by breaking a part thereof under excessive load torque has a structure provided with the fragile part in a power transmission route to be broken. The fragile part becomes fatigued due to variations in load, so that the torque at which the fragile part is broken, that is, the torque at which the limiter mechanism works cannot be uniquely defined.

In contrast, in a power transmission device 300 of the embodiment, a magnetic join portion 303 with few variations in magnetic characteristics also serves as the limiter mechanism. The torque at which the magnetic join portion 303 loses synchronization to idle, that is, the torque at which the limiter mechanism works varies relatively little as compared to an operation torque of the conventional limiter mechanism using the fragile part.

This is because the magnetic join portion has no fragile part and does not become fatigued due to variations in load.

That is, the torque at which the above magnetic join portion 303 loses synchronization to idle is set larger than the maximum torque at which the compressor 200 is normally driven, and smaller than at least one of the torque at which the belt is slipped, the toque at which the engine is stalled, and the maximum torque generated from a starter in starting of the engine. Accordingly, the more accurate protection function for the belt can be achieved.

More preferably, the torque at which the magnetic join portion 30 loses synchronization to idle is set smaller than the smallest one among the toque at which the belt is slipped, the toque at which the engine is stalled, the torque which can be generated from the starter in re-start of the engine, and further the torque at which a serious part is broken. In this case, it is possible to achieve the much more accurate belt protection function.

### Second Embodiment

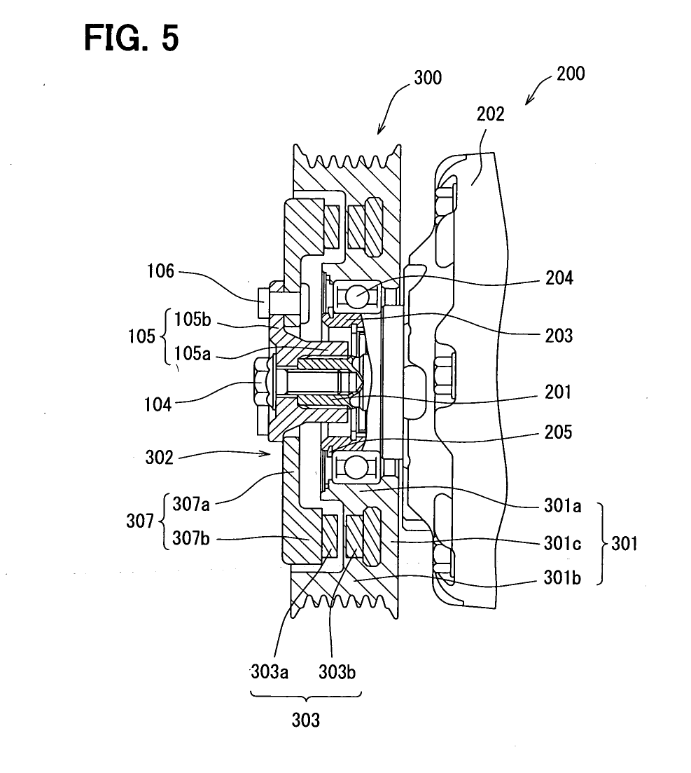

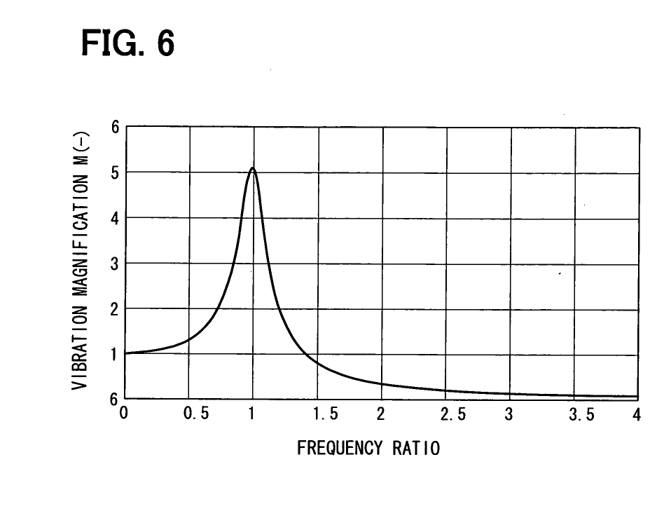

Next, the structure according to a second embodiment of the present invention will be described below with reference to FIG. 5. FIG. 5 is a cross-sectional view of a power transmission device 300 in the second embodiment. The second embodiment differs from the first embodiment in arrangement of driven permanent magnets 303a and driving permanent magnets 303b of the magnetic join portion 303. In the following description, the same components as those of the power transmission device 100 of the first embodiment, namely, the compressor 200, the drive shaft 201, the housing 202, the boss 203, the radial bearing 204, the collar 205, the bolt 104, the inner hub 105, and the rivet 106 are designated by the same reference numerals in FIG. 5, and the description thereof will be omitted below.

A pulley 301 of the embodiment includes an inner ring 301a rotatably supported by the boss 203 of the housing 202 via the radial bearing 204, an outer ring 301b having V-like grooves formed at its outer perimeter over which the belt (not shown) is looped, and a joint 301c for joining the inner ring 301a and the outer ring 301b. Unlike the first embodiment, the driving permanent magnet 303b of the magnetic join portion 303 is embedded in the joint 301c.

A hub 302 of the embodiment differs from that of the first embodiment in shape of an outer hub 307. The outer hub 307 includes a disk 307a fixed to the inner hub 105 by the rivet 106, and a ring-like protrusion 307b protruding from the end of the disk 307a in the radial direction toward the compressor 200 and extending into a space enclosed by the inner ring 301a, the outer ring 301b, and the joint 301c of the pulley 301.

The ring-like protrusion 307b has radial grooves (not shown) formed at its inner perimeter in parallel in the circumferential direction, and the driven permanent magnets 303a are fitted into these grooves and bonded thereto by an adhesive.

Also, in the embodiment, like the first embodiment, the groove (not shown) into which the driven permanent magnet 303a is fitted preferably has an area of a bottom surface wider than that of an opening of an entry portion. The type, performance, number, and the like of the permanent magnets included in the magnetic join portion 303 are the same as those of the first embodiment.

### Third Embodiment

Although in the above first and second embodiments, the present invention is applied to the pulley as the power transmission device by way of example, the present invention is not limited to the pulley. Alternatively, the present invention may be applied to an electromagnetic clutch as a power transmission device. When the present invention is applied to the electromagnetic clutch, the magnetic join portion is used instead of a rubber damper used in a conventional electromagnetic clutch, like the first and second embodiments.

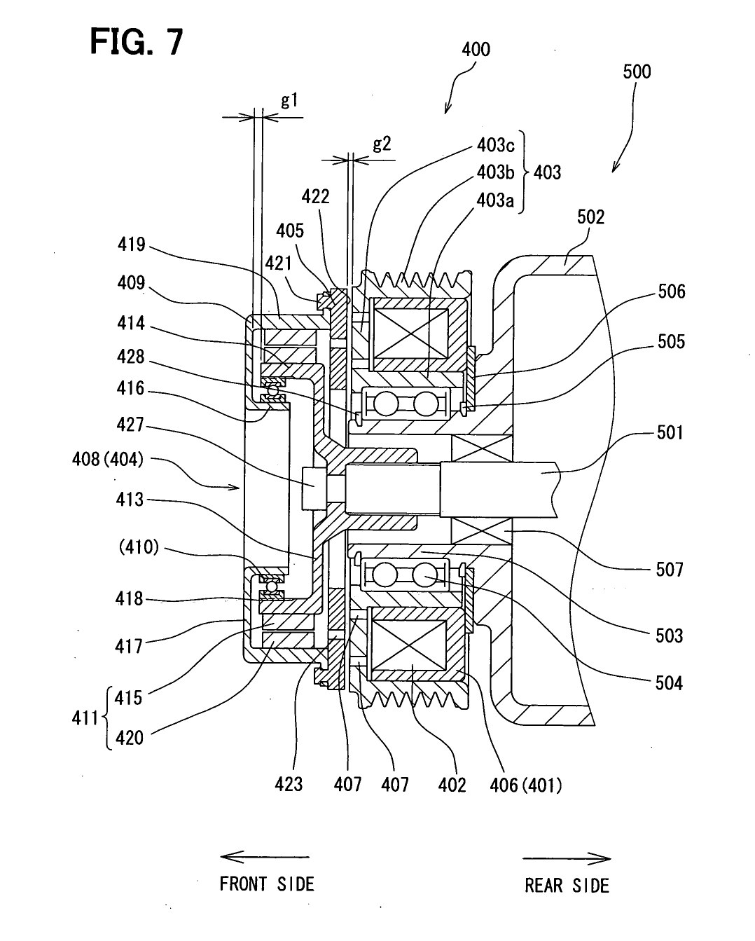

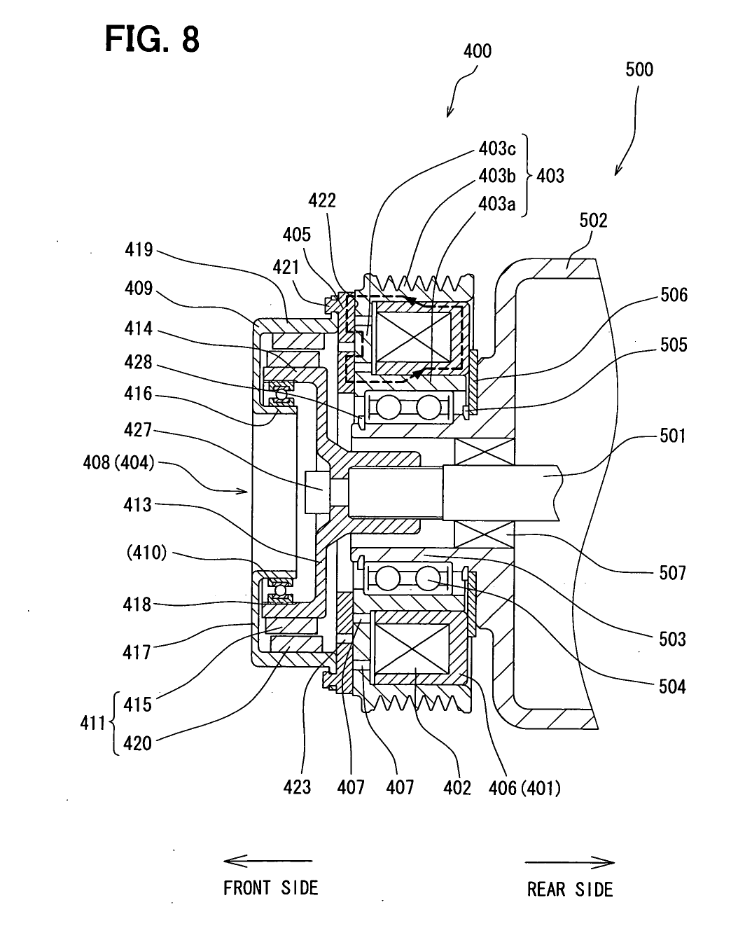

Now, a third embodiment of the present invention applied to the electromagnetic clutch will be described below with reference to FIGS. 7 and 8. FIG. 7 is a cross-sectional view of an electromagnetic clutch 400 of the embodiment.

The electromagnetic clutch 400 includes a stator 401 fixed to a housing 502 of a compressor 500, a rotor 403 rotatably supported by a boss 503 standing from the housing 401 via a radial bearing 504, a hub 404 attached to a drive shaft 501 of the compressor 500, and an armature 405 attached to the hub 404.

The stator 401 includes an electromagnetic coil 402, and a coil housing 406 for accommodating therein the electromagnetic coil 402. The coil housing 406 has a doughnut-like shape with an opened side of the U-shaped section directed toward the opposite side to the compressor 500, and a stator arm 506 is welded to the end surface of the coil housing 406 on the rear side. The stator arm 506 is fixed by a collar 505 to the end surface at which the boss 503 of the housing 502 of the compressor 500 stands. The electromagnetic coil 402 is comprised of a winding wire, and is an electromagnet which generates an electromagnetic force and to which power is supplied from an on-board battery via a feed terminal (not shown). The electromagnetic coil may be provided with a temperature fuse or the like.

The rotor 403 has a U-shaped section with an arc-shaped groove directed toward the compressor 500. The rotor 403 includes an inner ring 403a rotatably supported by the boss 503 via the radial bearing 504, an outer ring 403c having a V-like groove formed at its outer perimeter surface and over which a belt (not shown) is looped, and a joint 403c for connecting the inner ring 403a and the outer ring 403b. The radial bearing 504 is fixed to the boss 503 by a collar 428.

The joint 403c has a frictional surface which is brought into contact with the armature 405 when the armature 405 is sucked by an electromagnetic force generated from the electromagnetic coil 402. The frictional surface is provided with slits 407. The slits 407 are formed in double concentric circles, and contribute to allow magnetic field lines from the electromagnetic coil 402 to snake their way together with slits 423 provided in the armature 405 thereby to form a magnetic circuit shown by the arrow in FIG. 8.

The hub 404 includes an inner hub 408 attached to the drive shaft 501, an outer hub 409 mechanically coupled to the inner hub 408 and adapted to support the armature 405, a support mechanism 410 for displaceably and relatively rotatably supporting the inner hub 408 and the outer hub 409 in the axial direction of the compressor 500, and a magnetic join portion 411 for transmitting a rotary driving force of the outer hub 409 to the inner hub 408. The inner hub 408 and the outer hub 409 are made of a magnetic material.

The drive shaft 501 protrudes from the inside of the housing 502 which is made semi-hermetic by a shaft sealing unit 507. When the drive shaft 501 is rotatably driven, a compression mechanism (not shown) of the compressor 500 is driven to compress refrigerant sucked from a suction port (not shown), and then to discharge the refrigerant from a discharge port (not shown) to a refrigeration cycle.

The inner hub 408 includes a cylindrical portion 412 into which the tip of the drive shaft 501 is inserted, an inner hub plate 413 extending from the end of the cylindrical portion 412 on the opposite side to the compressor and expanding radially outward, and an inner-hub outer perimeter 414 extending from the edge of the outer perimeter of the inner hub plate 413 toward the opposite side to the compressor. The tip of the drive shaft 501 is turned fully and held in the cylindrical portion 412 by a spline or serration, and then fixed thereto by a bolt 427.

The inner-hub outer perimeter 414 has a cylindrical shape. The internal wall of the inner-hub outer perimeter 414 is provided with a groove into which a support mechanism 410 for supporting the outer hub 409 is slidably fitted in the axial direction. The external wall of the inner-hub outer perimeter 414 is provided with driven permanent magnets 415 included in the magnetic join portion 411. The inner-hub outer perimeter 414 serves as a back yoke of the driven permanent magnets 415.

The outer hub 409 includes a cylindrical outer-hub inner perimeter 416 supported by the support mechanism 410, and an outer-hub plate 417 expanding radially outward from the end of the outer-hub inner perimeter 416 on the opposite side to the compressor. The outer hub 409 further includes an outer-hub outer perimeter 419 extending from the edge of the outer perimeter of the outer-hub plate 417 toward the compressor and supporting the armature 405.

The outer-hub outer perimeter 419 has a cylindrical shape. An internal wall of the outer-hub outer perimeter 419 is provided with driving permanent magnets 420 included in the magnetic join portion 411. The end of the outer-hub outer perimeter 419 on the compressor side further extends radially outward, and is mechanically coupled to a fitting protrusion 421 of the armature 405. The outer-hub outer perimeter 419 acts as a back yoke of the driving permanent magnets 420.

The armature 405 is a doughnut-shaped plate with an armature side frictional surface 422 slidably in contact with the joint 403c of the rotor 403. The armature 405 is provided with the above-mentioned slits 423, and a fitting protrusion 421 protruding toward the opposite side to the armature side frictional surface 422.

The support mechanism 410 includes an outer ring 424 fitted into a groove 418 provided at the internal wall of the inner-hub outer perimeter 414 to be movable in the axial direction, an inner ring 425 fixed to the outer periphery of the outer-hub inner perimeter 416 by being pressed thereinto, and a radial bearing 426 disposed between the outer ring 424 and the inner ring 425. A gap g1 is provided between the end of the inner-hub outer perimeter 414 on the opposite side to the compressor and the outer-hub plate 417 such that the inner hub 408 and the outer hub 409 are relatively movable in the axial direction by the support mechanism 410. The above-mentioned groove 418 may be formed as the spline or serration.

The magnetic join portion 411 includes driving permanent magnets 420, and driven permanent magnets 415. Like the first embodiment, both the driven permanent magnet 415 and the driving permanent magnet 420 have an arc-shaped section. An even number of the driven and driving permanent magnets are respectively arranged adjacent to each other at equal intervals in the circumferential direction such that N poles and S poles are alternately arranged, and that the N pole of one magnet is opposed to the S pole of the other magnet facing the one magnet.

Like the first embodiment, the driven permanent magnet 415 and the driving permanent magnet 420 are desirably ones which have little change in magnetic force due to a change in temperature and which are not demagnetized even at 150° C. or more.

Also, like the first embodiment, a neodymium magnet or samarium-cobalt magnet is used as the driven permanent magnet 415 and the driving permanent magnet 420, and these permanent magnets are respectively attached to the inner-hub outer perimeter 414 and the outer-hub outer perimeter 419, and then magnetized.

The number of the driven permanent magnets 415 and the driving permanent magnets 420 in the embodiment, the gap in the radial direction between the driven permanent magnet 415 and driving permanent magnet 420 facing to each other, a distance between the permanent magnets adjacent to each other in the circumferential direction, and the axial dimension of the permanent magnet are the same as those of the first embodiment.

The inner-hub outer perimeter 414 and the outer-hub outer perimeter 419 have a thickness of 2 mm or more so as to serve as a back yoke by allowing most of magnetic fluxes generated from the driven permanent magnet 415 and the driving permanent magnet 420 to pass through the magnetic material. An effective diameter of the rotor 403 in the embodiment is about 100 mm.

The power transmission characteristics of the magnetic join portion 411 are the same as those of the magnetic join portion 103 described above with reference to FIG. 4 in the first embodiment.

Now, the operation of the electromagnetic clutch 400 of the embodiment will be described below. When a rotary driving force is transmitted from a driving source (engine) for vehicle traveling (not shown) to the rotor 403 via the belt, the rotor 403 is rotatably driven while incorporating therein the stationary stator 401.

When the electromagnetic coil 402 of the stator 401 is not energized, that is, when the electromagnetic clutch is turned off, the electromagnetic force is not generated from the electromagnetic coil 402. And, the armature 405 is supported by the outer hub 409 and the magnetic join portion 411 with a predetermined gap g2 from the frictional surface of the rotor 403.

Since in this state the rotor 403 is not in contact with the armature 405, the rotary power is not transmitted from the rotor 403 to the hub 404.

When the electromagnetic coil 402 of the stator 401 is energized, that is, when the electromagnetic coil is turned on, the electromagnetic force is generated from the electromagnetic coil 402, causing the armature 405 to be attracted to the frictional surface of the rotor 403. Thus, the rotary power is transmitted from the rotor 403 to the hub 404. When the rotary power is transmitted to the hub 404, the drive shaft 501 is rotatably driven thereby to drive the compressor 500.

At this time in the magnetic join portion 411, the driven permanent magnet 415 is not in contact with the driving permanent magnet 420, and the outer ring 424 of the support mechanism 410 is movable in the axial direction along the groove 418 of the inner hub 408. When the armature 405 is sucked toward the rotor 403 by the electromagnetic force, the outer hub 409 supporting the armature 405 itself moves toward the inner hub rotor 403 side, that is, the rotor 403 side.

When the energization of the electromagnetic coil 402 of the stator 401 is interrupted, the electromagnetic force generated from the electromagnetic coil 402 is eliminated, whereby the driven permanent magnet 415 and the driving permanent magnet 420 of the magnetic join portion 411 return to the original relative positional relationship before the energization. As a result, the armature 405 deviates from the frictional surface of the rotor 403.

As described in the first embodiment with reference to FIG. 4, in the range of angles where the sin(θ/X) is not less than 0 nor more than 1, the magnetic join portion 411 intends to reduce the displacement angle θ between the driven permanent magnet 415 and the driving permanent magnet 420, and thus serves as the conventional damper mechanism made of only elastic material, such as rubber or elastomer.

That is, according to the embodiment, like the first embodiment, the spring constant of the damper mechanism can be sufficiently decreased as the use of the damper mechanism made of only the elastic member, such as rubber or elastomer, so that the natural frequency of the power transmission device can be made much lower than the frequency of vibration (of about 80 Hz) generated from the vehicle-mounted rotary device in idling of the vehicle.

As a result, the frequency ratio of the frequency of vibration generated from the vehicle-mounted rotary device to the natural frequency of the electromagnetic clutch can constantly be much more than 1 (preferably, equal to or more than 1.5).

The maximum torque transmittable by the magnetic join portion 411 (torque obtained at sin(θ/X) of 1, that is, 30 Nm for A=30 in the embodiment) is set higher than the maximum torque normally generated by the compressor 500, and lower than the torque at which the rotor 403 starts to slip on the belt (not shown). In case where the drive shaft 501 of the compressor 500 is locked due to invasion of foreign material, even when the rotor 403 is intended to rotate at a torque larger than the maximum torque normally generated by the compressor 500, the outer hub 409 and the inner hub 408 idle without transmitting the torque larger than the maximum torque (torque at the sin(θ/X) of 1) to the inner hub 408 from the outer hub 409. Thus, the rotor 403 and the belt can be prevented from slipping, so that the damage to the belt can be avoided. Further, the rotor 403 and the armature 405 can be prevented in advance from producing friction to cause abnormal heat generation.

### Fourth Embodiment

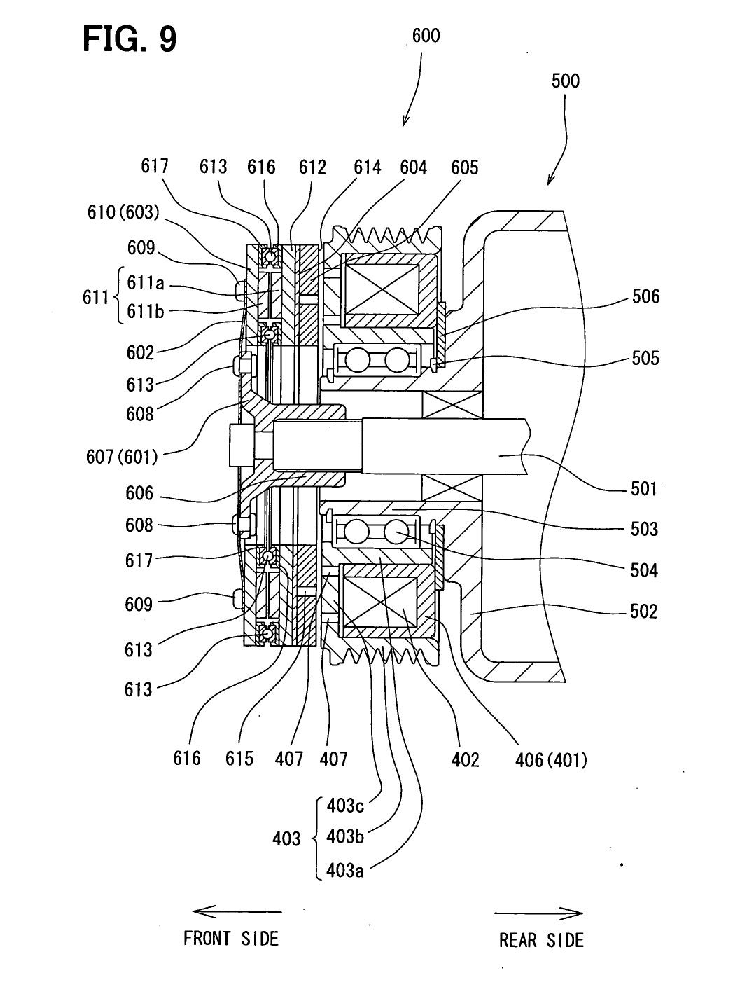

Next, the structure according to a fourth embodiment of the present invention will be described below with reference to FIG. 9. FIG. 9 is a cross-sectional view of an electromagnetic clutch 600 of the fourth embodiment. The fourth embodiment differs from the third embodiment in arrangement of driven permanent magnets and driving permanent magnets of a magnetic join portion. In the following description, the same components as those of the electromagnetic clutch 400 of the third embodiment, namely, the compressor 500, the drive shaft 501, the housing 502, the boss 503, the radial bearing 504, the collar 505, the stator 401, the electromagnetic coil 402, the rotor 403, the coil housing 406, and the slits 407 are designated by the same reference numerals in FIG. 9, and the description thereof will be omitted below.

The electromagnetic clutch 600 of the embodiment includes an inner hub 601 attached to the drive shaft 501 of the compressor 500; an outer hub 603 supported by the inner hub 601 via a plate spring 602, and an armature 605 attached via an insulator 604 on the back side.

The inner hub 601 includes a cylindrical portion 606 into which the tip of the drive shaft 501 is inserted and fixed, and a flange 607 extending radially outward from the end of the cylindrical portion 606 on the opposite side to the compressor. The inner perimeter of the plate spring 602 is attached to the edge of the outer periphery of the flange 607 by a plurality of rivets 608.

The outer hub 603 includes a driven plate 610 to which the outer perimeter of the plate spring 602 is attached by a plurality of rivets 609, a driving plate 612 opposed to the driven plate 610 via a magnetic join portion 611, and a thrust bearing 613 intervening in between the driven plate 610 and the driving plate 612.

The magnetic join portion 611 includes tooth portions 611a positioned on the driving side and made of magnetic material, and driven permanent magnets 611b. The type, performance, number, and the like of the permanent magnets included in the magnetic join portion 611 are substantially the same as those of the first to third embodiments. The tooth portion and the permanent magnet may be positioned on any one of the driving and driven sides so as to exhibit the same effects. Like the third embodiment, the magnets may be positioned on both sides. In a case where the driven side and the driving side are relatively rotated (that is, in a state of losing synchronization), the magnet on the driving side and the magnet on the driven side repeatedly attract and repel each other. Thus, it is necessary to add a thrust bearing such that the driven rotary is not spaced apart from the driving rotary in repelling.

The thrust bearing 613 is a roller thrust bearing disposed between the driven plate 610 and the driving plate 612. The axial dimension of a combination of the thrust bearing 613, a driving insulator 616, and a driven insulator 617 is set so as to make a predetermined gap between the tooth portion 611a made of magnetic material and positioned on the driving side of the magnetic join portion 611 and the driven permanent magnet 611b.

The armature 605 is a doughnut-shaped plate member including an armature side frictional surface 614 slidably in contact with the joint 403c of the rotor 403 like the above third embodiment. The armature 605 is provided with slots 615 of the same type as those of the third embodiment.

An armature back side insulator 604 is made of non-magnetic material, and is integral with the driving plate 612. The armature back side insulator 604 prevents excessive mutual interference between the magnetic flux generated by the electromagnetic coil 402 and the magnetic flux generated by the magnetic join portion 611.

Now, the operation of the electromagnetic clutch 600 in the embodiment will be described below. When a rotary driving force is transmitted from a driving source (engine) for vehicle traveling (not shown) to the rotor 403 via the belt, the rotor 403 is rotatably driven while incorporating therein the stationary stator 401.

When the electromagnetic coil 402 of the stator 401 is not energized, an electromagnetic force is not generated by the electromagnetic coil 402, and the armature 605 is supported by the plate spring 602 with a predetermined gap from the frictional surface of the rotor 403.

Since in this state the rotor 403 is not in contact with the armature 605, the rotary power is not transmitted from the rotor 403 to the inner hub 601.

When the electromagnetic coil 402 of the stator 401 is energized, the electromagnetic force is generated by the electromagnetic coil 402, causing the armature 605 to be attracted to the frictional surface of the rotor 403. Thus, the rotary power is transmitted from the rotor 403 to the inner hub 601.

At this time, when the armature 605 is sucked to the rotor 403 by the electromagnetic force, the plate spring 602 bends to cause the armature 605 to move toward the rotor 403.

When the energization of the electromagnetic coil 402 of the stator 401 is interrupted, the electromagnetic force generated from the electromagnetic coil 402 is eliminated, whereby the plate spring 602 returns to the original state before energization of the electromagnetic coil 402. As a result, the armature 405 deviates from the frictional surface of the rotor 403.

As described with reference to FIG. 4 in the first embodiment, in the range of angles where the sin(θ/X) is not less than 0 nor more than 1, the magnetic join portion 611 acts as a conventional damper mechanism made of only elastic member, such as rubber or elastomer, so as to decrease the displacement angle θ between the driven permanent magnet 611b and the driving permanent magnet 611a. In combining the magnets with the tooth portions, like the embodiment, the equation of X=N (the number of poles of the magnets and tooth portions) is obtained.

That is, in the embodiment, like the above-mentioned embodiments, the spring constant of the damper mechanism can be made sufficiently small as compared to that of the conventional damper mechanism made of only elastic material, such as rubber or elastomer. Further, the natural frequency of the power transmission device can be made much lower than the frequency (of about 80 Hz) of vibration generated from the vehicle-mounted rotary device in idling of the vehicle.

As a result, the frequency ratio of the frequency of vibration generated from the vehicle-mounted rotary device to the natural frequency of the electromagnetic clutch can constantly be much more than 1 (preferably, equal to or more than 1.5).

The maximum torque transmittable by the magnetic join portion 611 (torque obtained at sin(θ/X) of 1, that is, 30 Nm for A=30 in the embodiment) is set higher, than the maximum torque normally generated by the compressor 500, and lower than the torque at which the rotor 403 starts to slip on the belt (not shown). In case where the drive shaft 501 of the compressor 500 is locked due to invasion of foreign material, even when the rotor 403 is intended to rotate at a torque larger than the maximum torque normally generated by the compressor 500, the driving plate 612 and the driven plate 610 idle without transmitting the torque larger than the maximum torque (torque at the sin(θ/X) of 1) from the driving plate 612 to the driven plate 610 via the magnetic join portion. Thus, the rotor 403 and the belt can be prevented from slipping, so that the damage to the belt can be avoided. Further, the rotor 403 and the armature 605 can be prevented in advance from producing friction to cause abnormal heat generation.

The magnetic join portion according to each of the above second to fourth embodiments transmits the rotary driving force by the magnetic force while keeping a predetermined clearance between the driving permanent magnet and the driven permanent magnet in the same way as that performed by the magnetic join portion of the first embodiment.

### Other Embodiments

Since the above embodiments employ the magnetic join portion 103, a limiter mechanism or a rubber damper does not need to be provided. However, the present invention is not limited thereto, and a limiter mechanism or rubber damper which is broken due to excessive load toque may be employed together with the magnetic join portion.

Although in the first to third embodiments, the magnetic join portion is comprised of the driven permanent magnets and the driving permanent magnets, the present invention is not limited thereto. As described in the fourth embodiment, at least one of the driving and driven sides may employ permanent magnets. Alternatively, instead of the permanent magnet, an electromagnet may be used.

When magnets of a magnetic join portion are arranged on only one of the driven and driving sides, magnetic blocks having the same shape as that of the magnet are arranged on the other side in a ring shape, while being opposed to the magnets.

According to the first and second embodiments of the present invention, the power transmission device is provided for transmitting a driving force from the vehicle-mounted driving source to a refrigerant compressor for a car air conditioner. The power transmission device includes a pulley coupled to the vehicle-mounted driving source via the belt, and rotatably supported by the housing of the refrigerant compressor for the car air conditioner, the pulley having a concave portion at an end surface in the axial direction on the opposite side to the refrigerant compressor for the car air conditioner in the axial direction. The power transmission device also includes an inner hub disposed coaxially with the pulley, and fastened to the drive shaft of the refrigerant compressor for the car air conditioner, and an outer hub disposed at the outer periphery of the inner hub and facing the concave portion of the pulley. The power transmission device further includes a driving magnetic material disposed in the concave portion of the pulley, and a driven magnetic material disposed at the outer hub. The outer hub rotates accompanied with the pulley, while keeping a predetermined clearance between the driving magnetic material and the driven magnetic material by a magnetic attractive force between the driving magnetic material and the driven magnetic material. However, the present invention is not limited thereto.

Although in the above embodiments, the maximum torque transmittable by the magnetic join portion is 30 Nm by setting the amplitude to 30 (A=30) by way of example, the present invention is not limited thereto. Alternatively, the maximum torque transmittable by the magnetic join portion can be not less than 15 Nm nor more than 150 Nm.

1. A power transmission device for transmitting a driving force from a vehicle-mounted driving source to a compressor included in a refrigeration cycle of an air conditioner for a vehicle via a belt, the power transmission device comprising:
a driving rotor coupled to the vehicle-mounted driving source via the belt;
a driven rotor disposed coaxially with the driving rotor and mechanically coupled to a drive shaft of the compressor; and
a magnetic join portion disposed in at least one of the driving rotor and the driven rotor, the magnetic join portion being adapted to transmit a rotary driving force from the driving rotor to the driven rotor by a magnetic force, while keeping a predetermined clearance between the driving rotor and the driven rotor,
wherein a maximum rotary driving force transmitted from the driving rotor to the driven rotor by the magnetic join portion is set larger than a maximum torque required by the compressor, and smaller than at least one of a torque at which the driving rotor and the belt start to slip, a torque at which the vehicle-mounted driving source is to be stopped, and a maximum torque generated from a starter in startup of the vehicle-mounted driving source.

2. The power transmission device according to claim 1, wherein the magnetic join portion includes a plurality of permanent magnets arranged in a circumferential direction.

3. The power transmission device according to claim 1, wherein the maximum rotary driving force transmitted from the driving rotor to the driven rotor by the magnetic join portion is set to not less than 15 Nm and not more than 150 Nm.

4. The power transmission device according to claim 1, wherein the magnetic join portion includes a driving permanent magnet provided in the driving rotor and a driven permanent magnet provided in the driven rotor.

5. The power transmission device according to claim 4, wherein the magnetic join portion includes a plurality of sets of the driving permanent magnets and the driven permanent magnets opposed to each other and arranged in the circumferential direction, and
wherein the respective sets of the driving permanent magnets and the driven permanent magnets opposed to each other are arranged with a predetermined gap therebetween.
